(19) United States
(12) Patent Application Publication
(10) Pub. No.: US 2018/0194682 A1
(43) Pub. Date: Jul. 12, 2018

(54) NOVEL SHRINKAGE-REDUCING AGENTS FOR MINERAL BINDERS

(71) Applicants: Frank Schubert, Neukirchen-Vluyn (DE); Anke Reinschmidt, Essen (DE); Andreas Vetter, Essen (DE); Sabina Kruczek, Essen (DE); Dieter Honert, Suzhou SIP (CN); Thomas Müller, Heidelberg (DE); Inna König, Schönau (DE); Oliver Blask, Oftersheim (DE); Arndt Eberhardt, Winterthur (CH)

(72) Inventors: Frank Schubert, Neukirchen-Vluyn (DE); Anke Reinschmidt, Essen (DE); Andreas Vetter, Essen (DE); Sabina Kruczek, Essen (DE); Dieter Honert, Suzhou SIP (CN); Thomas Müller, Heidelberg (DE); Inna König, Schönau (DE); Oliver Blask, Oftersheim (DE); Arndt Eberhardt, Winterthur (CH)

(21) Appl. No.: 15/741,524

(22) PCT Filed: Jul. 6, 2016
(86) PCT No.: PCT/EP2016/065939

§ 371 Date: Jan. 3, 2018

(30) Foreign Application Priority Data
Jul. 20, 2015 (EP) 15177467.6

(51) Int. Cl. C04B 20/10; C08G 63/66; C04B 28/02

(52) U.S. Cl. CPC C04B 20/1037; C04B 2103/58; C04B 28/02; C08G 63/66

(57) ABSTRACT

The invention relates to the use of carboxylic acid-based polyoxyalkylenes as low-emissions shrinkage reducers in mineral binders, to methods of reducing shrinkage and to corresponding compositions.

The invention provides carboxylic acid-based polyoxyalkylenes as novel low-emissions shrinkage-reducing agents for mineral binders, especially cementitious binders, and building materials produced therefrom, for example mortars, screeds, concretes and slurries.

It has long been known to those skilled in the art that mineral binders, especially cementitious binders, are subject to a contraction in volume during the setting and drying process. This shrinkage is of very great significance for suitability for use, for sustained service life and for strength of the hardened building material, since it is frequently the cause of the formation of cracks, of the dishing of screeds and further faults. In this way, for example, water, dissolved salts and air get through cracks into the interior of the concrete, mortar, screed or slurries and promote corrosion, for example, in reinforced concrete constructions. Moreover, the cyclical stress caused by frost and thaw, with unwanted penetration of water into the building material, leads to mechanical stresses and early material failure.

The construction industry is therefore trying to limit shrinkage to a minimum through a wide variety of different measures. Attempts have been made to counteract shrinkage not just via the way in which construction is executed and choice of optimized cementitious binder compositions, but in recent times to an increased degree via the addition of organic additives. In the early 1980s, the first shrinkage reducers were developed and successfully used in Japan (P. Schäffel, Betontechnische Berichte 2007-2009, p. 19-37). Since then, the use of various shrinkage reducers as an admixture has become widespread and has also been the subject of scientific studies relating to the mechanism of action (P. Schaffel, Thesis, University of Weimar, 2009).

The prior art includes various types of glycols and polyoxyalkylenes that are used as shrinkage reducers. For example, U.S. Pat. No. 4,547,223 discloses the use of polyoxyalkylenes which are prepared proceeding from an alkanol having 1 to 7 carbon atoms or an OH-functional cycloaliphatic compound having 5 or 6 carbon atoms and contain 1 to 10 monomer units of ethylene oxide and/or propylene oxide. GB 2305428 describes the shrinkage-reducing effect of various glycols such as 2-methylpentane-2,4-diol and alkoxylation products prepared therefrom having 2-10 units of ethylene oxide and/or propylene oxide. EP 1024120, by contrast, relies on particular alkanolamines such as N-propylaminopropanol or N-butylaminopropanol. Polyethylene glycols having molar masses between 400 and 8000 g/mol are claimed in JP 2011246286 as shrinkage reducers, while CN 100347139 describes fatty alcohol ethoxylates formed from C₁₂-C₁₈ fatty alcohols with 15 to 17 ethyleneoxy units. Polyoxyalkylenes which derive from polyols having at least three OH groups and have between 30 and 50 oxyalkylene units per OH group are used in JP 2010229015 for reduction of shrinkage in hydraulic binders. Several property rights are concerned with the use of butanol-based polyoxyalkylenes, for example the document JP 2004091259 (1 to 20 oxyethylene or oxypropylene units) and CN 102020432 with exclusively oxypropylene units.

In addition, it is known that glycols and polyoxyalkylenes can be added to cementitious systems in pulverulent, usually supported form. The method set out in JP 2011184236 is based on applying a polyoxyalkylene having 1 to 100 oxyalkylene units bonded to an alkanol having 1 to 8 carbon atoms to an inorganic pulverulent support material. For example, 80 g of active ingredient on 160 g of support material are converted to a solid application form by absorption.

All these shrinkage reducers have one or more disadvantages. They are uneconomic because of the high dosage and/or the cost of production thereof, they disrupt the action of air pore formers owing to their surface activity, they cannot viably be used on construction sites because of their flammability/flashpoint, or they delay the evolution of strength of the cementitious systems.

A further problem with the organic shrinkage reducers known to date that has not been solved to date is the vapor pressure thereof. During and after processing over a large area, as for example in screeds, there is outgassing of the volatile substances. Conventional shrinkage reducers are thus volatile organic compounds (VOCs). When employed in dwellings, they contribute to pollution of the breathable air, which is being tolerated to an ever lesser degree as in the case of carpets, furniture and plastics. Especially low molecular weight glycols and polyoxyalkylenes, but also those polyoxyalkylenes which, on account of the production process therefor, have a broad molar mass distribution with low molecular weight components or contain by-products of low molecular weight, can constitute sources of VOCs. Permanent gradual outgassing from the building material may possibly impair the mechanical properties of the building material in the long term.

Because of the potentially health-damaging effect of volatile organic compounds in room air, floorcoverings and floorcovering adhesives have been tested by defined test methods for years, and particularly low-emissions materials are awarded quality seals. Materials that meet the strict criteria of EMICODE EC1 and the Blaue Engel, for example, are very particularly low-emissions products. Ever more attention has been paid in recent times to screeds laid indoors, which, with their organic admixtures, are likewise possible VOC sources. There are no known organic shrinkage reducers to date for hydraulic binders which, at customary concentrations, meet the demands of EMICODE EC1 or similar test standards, for example.

The problem addressed by the present invention was therefore that of providing a low-emissions and virtually VOC-free shrinkage-reducing agent for hydraulic binders. A particular problem addressed was that of providing shrinkage reducers which meet the criteria of the Ausschuss zur gesundheitlichen Bewertung von Bauprodukten (AgBB, German Committee for Health-related Evaluation of Building Products), February 2015 version.

A further problem addressed by the present invention is that of providing building materials produced with shrinkage reducers that meet the AgBB criteria of TVOC₃≤10 mg/m³, TVOC₂₈≤1.0 mg/m³ and SVOC₂₈≤0.1 mg/m³ and hence are particularly suitable for use very particularly indoors as well. (TVOC=total volatile organic compounds) on day 3 or 28, SVOC=semivolatile organic compounds on day 28.

The shrinkage reducers according to the invention are to be producible and usable either in liquid form (neat or dilute) or in solid form, for example in supported form, in order to enable maximum flexibility on application. At the same time, the shrinkage reducers may also be used as a constituent of a product formulation with further substances.

A further problem addressed by the present invention is that of providing a new class of shrinkage reducers which are not just low in emissions in the sense of the aforementioned definition, inexpensively producible and easily processible, but which also display at least as good a shrinkage-reducing action as achieved by the products known from the prior art.

When ranges, general formulae or classes of compounds are specified below, these are intended to encompass not only the corresponding ranges or groups of compounds which are explicitly mentioned but also all subranges and subgroups of compounds which can be derived by leaving out individual values (ranges) or compounds. Where documents are cited for the purposes of the present description, the entire content of these is intended to be part of the disclosure of the present invention. Where percentage figures are given hereinafter, unless stated otherwise, these are figures in % by weight. In the case of compositions, the percentage figures, unless stated otherwise, are based on the overall composition. Where average values are given hereinafter, unless stated otherwise, these are mass averages (weight averages). Where measured values are given hereinafter, unless stated otherwise, these measured values were determined at a pressure of 101 325 Pa and at a temperature of 25° C.

It has been found that, surprisingly, particular polyoxyalkylenes having one or more carboxyl groups in the polymer chain and one or more terminal hydroxyl groups are of excellent suitability as low-emissions shrinkage reducers. Polyoxyalkylenes of this kind, either in liquid or solid form, if desired supported on an inorganic absorbing substrate, can be used in a versatile manner, for example in mortars, cement and concretes or slurries, and show excellent shrinkage-reducing action in such mineral binder compositions. Studies according to DIN 52450 demonstrate that self-levelling cement screeds comprising the shrinkage reducers according to the invention have a very low shrinkage of less than 0.4 mm per m after 14 days.

In the context of the present invention, low-emissions and VOC-free shrinkage reducers are considered to be those that meet the criteria of the German Committee for Health-related Evaluation of Building Products (AgBB), February 2015 version. These criteria are known to those skilled in the art. These have been published by the German Environment Ministry on its webpage: http://www.umweltbundesamt.de/sites/default/files/medien/355/dokumente/agbb-bewertungsschema_2015_2.pdf.

These shrinkage reducers according to the invention are not volatile organic compounds (VOCs). Nor do they contain any ingredients or by-products that would themselves be classified as VOCs. The screeds and other building materials produced therewith are thus likewise virtually free of unwanted VOCs and meet the AgBB criteria.

There is no single definition of the term “VOC”, and the analytical determination methods are correspondingly different. A widespread definition of VOCs is derived from the volatility (boiling point) of a substance or substance mixture. Accordingly, the term “VOC” describes a substance having a boiling point of not more than 250° C. Quick VOC tests with the aid of a GC-based test method are of particularly good suitability particularly in the case of high numbers of samples and permit rapid and meaningful characterization of the emissions characteristics and comparisons of the samples with one another. VOC measurements by a GC method against tetradecane as standard demonstrate that the shrinkage reducers according to the invention are not VOCs and the proportion of volatile constituents is extremely low. Conventional shrinkage reducers such as neopentyl glycol and hexylene glycol, by contrast, are 100% VOCs.

These results are confirmed in costly and inconvenient 28-day test chamber methods in which the emissions properties of mortars containing the polyoxyalkylenes according to the invention as admixtures were examined. In accordance with the GEV (Gemeinschaft Emissionskontrollierte Verlegewerkstoffe, Klebstoffe und Bauprodukte e. V. [German Association for the Control of Emissions in Products for Flooring Installation, Adhesives and Building Materials]) test method (Apr. 15, 2013 version), freshly prepared mortar samples in large-volume test chambers in which defined indoor climatic conditions have been simulated at 23° C. were flushed continuously with clean air and the chamber air was exchanged at particular intervals. At intervals of several days, air samples were taken from the test chamber and the volatile organic constituents were identified by GC-MS and HPLC and added up. The binder compositions modified with shrinkage reducers of the formula (I) below are found in such tests to be extremely low in emissions compared to the prior art admixtures examined.

A further advantage of the compounds according to the invention is that they are easily processible. In relation to the setting speed and mechanical indices of the cured binder system, the polyoxyalkylenes according to the invention are surprisingly found to be neutral.

A further great advantage of the low-emissions shrinkage reducer of the formula (I) below is also that, in the case of use thereof, cementitious screeds have the same properties as gypsum-based screeds, namely that they are low in emissions and do not have any shrinkage, combined with simultaneously better mechanical strengths and higher water resistance.

### Composition of the Low-Emissions Shrinkage Reducers According to the Invention:

The present invention thus provides for the use of polyoxyalkylenes of the formula (I) as shrinkage-reducing agents (shrinkage reducers)

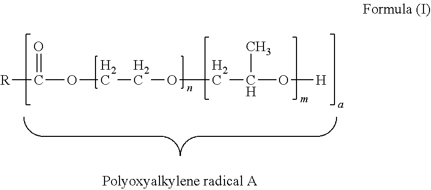

where
R is an a-valent, linear or branched, saturated, monounsaturated or polyunsaturated, aliphatic, cycloaliphatic or aromatic hydrocarbyl radical having 3 to 38 carbon atoms, preferably having 5 to 17 carbon atoms, where the hydrocarbyl chain is substituted by a polyoxyalkylene radicals A, preferably in the terminal position in the case of linear hydrocarbyl chains (i.e. at one or both ends of the linear hydrocarbyl chain), “substituted” in the present context meaning that one hydrogen atom of the hydrocarbyl radical R in each case is replaced by a polyoxyalkylene radical A,
   R preferably being a linear or branched, saturated, monounsaturated or polyunsaturated, aliphatic hydrocarbyl radical having 3 to 38 carbon atoms, preferably having 5 to 17 carbon atoms, where the hydrocarbyl chain is terminally substituted by 1 or 2 (a=1 or 2), preferably by 1, polyoxyalkylene radical(s) A,
   R more preferably being a linear, saturated or unsaturated, aliphatic hydrocarbyl radical having 5 to 17 carbon atoms, where the hydrocarbyl chain is terminally substituted by a polyoxyalkylene radical A (a=1),
a=1 to 4, preferably less than 3, further preferably 1 to 2, especially preferably 1,
n=0 to 40, preferably 2 to 30, especially preferably 4 to 20,
m=0 to 40, preferably 2 to 30, especially preferably 4 to 20,
   with the proviso that
   the sum total of n and m=4 to 80, preferably from 6 to 40, more preferably 8 to 20, where the units that n and m refer to are distributed in the polyether chain either in blocks or randomly and the units that n and m refer to constitute the mean values of the possible statistical distribution of the actual structures present.

The polyoxyalkylene radical A corresponds to the fragment with the index a in formula (I).

It is a particular feature of shrinkage reducers of the formula (I) that they are low in emissions and meet the aforementioned AgBB criteria.

Shrinkage-reducing agents in the context of this invention are organic compounds that reduce the shrinkage of hydraulic binders. The shrinkage occurs during the drying operation through capillary suction that arises as a result of internal chemical shrinkage or in the event of very low outside air humidity. The use of a shrinkage reducer reduces the stresses and prevents or limits cracking. The function and mode of action have been described many times and in detail in the literature (Eberhardt 2011; “On the mechanisms of shrinkage reducing admixtures in self consolidating mortars and concretes”; ISBN 978-3-8440-0027-6).

Statistical distributions may have a blockwise structure with any number of blocks and any sequence or be subject to a randomized distribution; they may also have an alternating structure or else form a gradient along the chain; in particular, they can also form any mixed forms thereof in which groups of different distributions may follow one another.

Preference is given to the use of polyoxyalkylenes of the formula (I) where the R radical is independently an aliphatic hydrocarbyl radical having 3 to 38 carbon atoms, preferably having 5 to 17 carbon atoms, where the carbon chain is terminally substituted by 1 or 2 polyoxyalkylene radicals A and hence a is the number of polyoxyalkylene radicals A and is 1 or 2, the R radical more preferably being branched with 5 to 17 carbon atoms and the index a being 1.

The polyoxyalkylenes of the formula (I) can be prepared by an alkoxylation reaction of carboxylic acids of the formula (II)

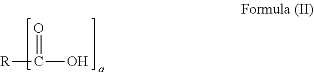

where
R is the a-valent radical of an organic carboxylic acid as defined in formula (I)
with alkylene oxides such as ethylene oxide and/or propylene oxide.

Preferred R radicals for formula (I) and formula (II) are those which derive from compounds from the group of the mono- or polybasic carboxylic acids, the aromatic carboxylic acids or the cycloaliphatic carboxylic acids. Particular preference is given to the R radicals which derive from a fatty acid or dimer fatty acid. Especially preferred are the R radicals which derive from hexanoic acid, heptanoic acid, octanoic acid, nonanoic acid, decanoic acid, undecanoic acid, dodecanoic acid, tridecanoic acid, tetradecanoic acid, pentadecanoic acid, hexadecanoic acid, heptadecanoic acid, octadecanoic acid, nonadecanoic acid, eicosanoic acid, 2-ethylhexanecarboxylic acid, isononanoic acid, 3,5,5-trimethylhexanecarboxylic acid, neodecanoic acid, isotridecanecarboxylic acid, isostearic acid, undecylenoic acid, oleic acid, linoleic acid, ricinoleic acid, linolenic acid, benzoic acid, cinnamic acid, phthalic acid, isophthalic acid, terephthalic acid, cyclohexanecarboxylic acid, hexahydrophthalic acid, tetrahydrophthalic acid, methyltetrahydrophthalic acid or the dimer fatty acids that derive from the aforementioned unsaturated carboxylic acids. From the aforementioned group, particular preference is further given to the R radicals which derive from hexanoic acid, heptanoic acid, octanoic acid, nonanoic acid, decanoic acid, undecanoic acid, dodecanoic acid, tridecanoic acid, tetradecanoic acid, pentadecanoic acid, hexadecanoic acid, heptadecanoic acid, octadecanoic acid, nonadecanoic acid, eicosanoic acid, 2-ethylhexanecarboxylic acid, isononanoic acid, 3,5,5-trimethylhexanecarboxylic acid, neodecanoic acid, isotridecanecarboxylic acid, isostearic acid, undecylenoic acid, oleic acid, linoleic acid, ricinoleic acid, linolenic acid or the dimer fatty acids that derive from the aforementioned unsaturated carboxylic acids, very particular preference to hexanoic acid, heptanoic acid, octanoic acid, nonanoic acid, decanoic acid, undecanoic acid, dodecanoic acid, tridecanoic acid, tetradecanoic acid, pentadecanoic acid, hexadecanoic acid, heptadecanoic acid, octadecanoic acid, nonadecanoic acid, eicosanoic acid, 2-ethylhexanecarboxylic acid, isononanoic acid, 3,5,5-trimethylhexanecarboxylic acid, neodecanoic acid, isotridecanecarboxylic acid, isostearic acid, undecylenoic acid, oleic acid, linoleic acid, ricinoleic acid or linolenic acid, and especial preference to isononanoic acid, 3,5,5-trimethylhexanecarboxylic acid, neodecanoic acid, isotridecanecarboxylic acid, oleic acid.

Polyoxyalkylenes of the formula (I) where the R radicals derive from the aforementioned carboxylic acids are of particularly excellent suitability as shrinkage reducers, have particularly good properties with regard to processibility, and when used as shrinkage reducers achieve building materials having the desired properties.

In addition, it is also possible to use aromatic carboxylic acids of the formula (II), for example benzoic acid, cinnamic acid, phthalic acid, isophthalic acid, terephthalic acid or cycloaliphatic carboxylic acids such as cyclohexanecarboxylic acid, hexahydrophthalic acid, tetrahydrophthalic acid or methyltetrahydrophthalic acid.

The polyoxyalkylenes of interest here are polyether alcohols, often also referred to as polyethers or polyetherols for short. The prior art includes various documents in which alcohols, carboxylic acids or amines are used as starter compounds for the alkoxylation reaction. A good overview of polyoxyalkylenes and processes for preparing polyoxyalkylenes is given by “N. Schonfeldt, Surface Active Ethylene Oxide Adducts, Pergamon Press, 1969”.

The polyoxyalkylenes according to the invention preferably have a weight-average molar mass of 300 to 15 000 g/mol, more preferably of 400 to 5000 g/mol and especially preferably of 500 to 2500 g/mol.

Particular preference is given to the polyoxyalkylenes according to the invention with n=0 to 20, m=0 to 20 and a sum total of m+n=6 to 20.

Especially preferred are the polyoxyalkylenes according to the invention where R is a monovalent (a=1) branched hydrocarbyl radical having 5 to 17 carbon atoms and with n=0 to 20, m=0 to 20 and a sum total of m+n=6 to 20.

The compounds according to the invention that are used as shrinkage reducers preferably also include polyoxyalkylenes that have originated from mixtures of various carboxylic acids, e.g. mixtures of different native fatty acids and mixtures of monomer/dimer/trimer fatty acids. If a plurality of starter compounds are used as a mixture, the index a may also be subject to a statistical distribution.

The polyoxyalkylenes according to the invention are preferably colorless to yellow/orange products that may be clear or opaque. According to the structure of the polyoxyalkylene chain, the products are liquid, waxy or solid at room temperature. Preference is given to liquid and low-viscosity products with less than 1000 mPas (25° C.).

The inventive low-emissions shrinkage reducers of the formula (I) can be prepared by the processes known in the prior art; they are preferably prepared by the process which follows. In the first step, a starter compound of the formula (II) is reacted catalytically with ethylene oxide, propylene oxide or any desired mixtures of these epoxides. In an optional second step, residual monomers are removed in a vacuum distillation and the reaction product is neutralized with an acid such as lactic acid, acetic acid, propionic acid or phosphoric acid, and the salts formed are optionally removed by filtration.

In the context of the present invention, starter compounds are understood to mean substances forming the beginning (start) of the polyoxyalkylene to be prepared which is obtained by addition of alkylene oxides.

The epoxide monomers can be used in pure or mixed form. It is also possible to effect continuous metered addition over time of a further epoxide into an epoxide already present in the reaction mixture in order to bring about an increasing concentration gradient of the continuously added epoxide. The polyoxyalkylenes formed are thus subject to a random distribution in the end product. The correlations between metered addition and product structure are known to those skilled in the art.

Catalysts used for the alkoxylation reaction are the alkaline catalysts known to those skilled in the art, such as potassium hydroxide, potassium hydroxide solution, sodium methoxide or potassium methoxide. Starter compound and catalyst are initially charged in the reactor at the start of the process prior to the metered addition of alkylene oxide, it being necessary to adjust the amount of catalyst so as to give sufficient catalytic activity for the process. The reaction temperature in the first step is preferably 80 to 220° C., more preferably 100 to 180° C. The pressure in the first step is preferably 0.5 bar to 20 bar, preferably 1.0 bar to 12 bar (absolute).

After the epoxide addition has ended, there preferably follows a period of further reaction for completion of the conversion. The further reaction can be conducted, for example, by continued reaction under reaction conditions (i.e. maintenance, for example, of the temperature and the pressure) without addition of reactants. Preferably, the further reaction is effected with mixing of the reaction mixture, especially with stirring.

Unreacted epoxides and any further volatile constituents can be removed directly at the end of the first step, for example, by vacuum distillation, steam or gas stripping, or other methods of deodorization.

Reactors used for the alkoxylation in the first process step may in principle be any suitable reactor types that allow control over the reaction and its exothermicity. The first process step can be effected continuously, semi-continuously or else batchwise, in a manner known in chemical engineering.

### Use of the Low-Emissions Shrinkage Reducers:

The present invention further provides a method of reducing shrinkage of building materials comprising mineral binders, especially cementitious binders. The building materials are preferably mortar, screed, concrete or slurries. In the context of the method, at least one polyoxyalkylene of the formula (I) as described above is added to an unhardened or unset building material mixture. The mineral binder is preferably a hydraulic binder, more preferably a cement according to European Standard EN 197 in neat form or as a blend with latently hydraulic binders, preferably fly ash, blast furnace slag, burnt oil shale, natural pozzolans or fumed silica or inert fillers such as rock flour. In the context of the method described, it is further preferable when the at least one polyoxyalkylene of the formula (I) is added to the unhardened building material mixture in an amount of 0.001%-60.0% by weight, preferably in an amount of 1% to 3% by weight, based on the dry weight of the binder. The term “unhardened building material mixture” should be interpreted in this context such that the mixture, at the time of addition, does not necessarily contain all the constituents of the later building material; in other words, it is possible, for example, that further ingredients required for the desired building material, such as water or aggregate, are added after the addition of the at least one polyoxyalkylene of the formula (I). The term “unhardened” should be interpreted such that the mineral binder is in unset or at least incompletely set form, such that the mixture is free-flowing and preferably pumpable.

The polyoxyalkylene of formula (I) can be used in liquid form, as a powder, for example in supported, dispersed or emulsified form in water and/or a nonaqueous solvent, or dissolved in water and/or a nonaqueous solvent. It is possible either to premix the polyoxyalkylene of formula (I) in at least one hydraulic binder or to employ it in dry mortar or concrete. The mixing of the polyoxyalkylene of the formula (I) into the binder can be effected before, during or after the grinding in the production of the binder in the factory.

In the supporting operation, one or more inventive polyoxyalkylenes of the formula (I) are absorbed, encapsulated or adsorbed on a support or mixed with a support material, where the support material may be selected from inorganic or organic materials or mixtures thereof, preferably silicas, alumina, sand, cement, volcanic rock, for example basalt or pumice, fly ash, bentonites, xonotlites or lime or starch, cellulose, wood pellets or proteins, plastics pellets, particular preference being given to using inorganic support materials for reasons of cost. More particularly preferred support materials are silicas, alumina and pumice, silicas being especially preferred.

It may be appropriate when the at least one polyoxyalkylene of the formula (I), the mineral binder, admixtures, additives and/or aggregate are first mixed without addition of water and water is added to the premix thus obtained only at a later juncture. Alternatively, however, it is also possible to mix the individual components, i.e. the at least one polyoxyalkylene of the formula (I), the mineral binder, admixtures, additives and/or aggregate directly with water. In addition, the at least one polyoxyalkylene of the formula (I) can be mixed with the mineral binder and/or the rock flour during the process of production or delivery of the building material. For this purpose, the at least one polyoxyalkylene of the formula (I) can be added directly to the mixture, for example to the binder, mortar or concrete which is in dry form or has been mixed with water at the factory, at the building site, in the mixer, in the delivery pump or via a static mixer with a powder metering unit or a liquid metering unit.

In the present context, “building material” refers to a mixture consisting of one or more mineral binders and water, preferably of one or more mineral binders, aggregate and water. The building material is more preferably a concrete, mortar, screed or slurries. The expression “mineral binder” is especially understood to mean a binder which reacts in the presence of water in a hydration reaction to give solid hydrates or hydrate phases. This may comprise, for example, a hydraulic binder (e.g. cement or hydraulic lime), a latently hydraulic binder (e.g. foundry sand), a pozzolanic binder (e.g. fly ash), a non-hydraulic binder (e.g. gypsum, white lime) or a mixture of two or more of these binders. “Cement” or “cementitious binder” is understood predominantly to mean a binder or binder composition having a proportion of at least 5% by weight, especially at least 20% by weight, preferably at least 35% by weight, specifically at least 65% by weight, of cement clinker. The cement clinker is preferably a portland cement clinker. The present invention is suitable, for example, for cements according to the standard EN 197-1, especially for cement of the CEM I, CEM II, CEM III, CEM IV and/or CEM V type. Also suitable, of course, are cement types that are classified under another standard or unclassified (e.g. high-alumina cement, calcium sulfoaluminate cement, belite cement, geopolymers, and blends thereof).

As well as the at least one polyoxyalkylene of the formula (I) according to the invention, the building material or the aforementioned building material mixture may comprise customary admixtures. Examples are concrete plasticizers, superplasticizers, corrosion inhibitors, defoamers, air pore formers, polymer dispersions, accelerators, retardants, stabilizers, viscosity modifiers, redispersion powders, water retention aids, fibers (e.g. steel or polymer fibers), sealants. In addition, the building material or building material mixture may comprise customary admixtures, for example fly ash, foundry sand, rock flour (e.g. quartz/limestone flour), fibers (e.g. steel or polymer fibers), pigments, trass, polymer dispersion. In addition, the building material or building material mixture may comprise aggregate, for example sand, gravel, spall and/or stones. It is immaterial here whether mineral binders, admixtures, additives, aggregate, etc. are premixed in the form of a “dry mix” and the latter is blended with water at a later juncture, or the individual components are mixed together with water.

A further aspect of the present invention relates to a building material composition comprising

i) at least one mineral binder, preferably a cementitious binder, and
ii) at least one polyoxyalkylene of the formula (I) as described above. In respect of preferred embodiments with regard to the configuration of the at least one polyoxyalkylene of the formula (I), the content thereof in the composition and further ingredients of the building material composition, reference is made to the above details, including the details with regard to building materials and building material mixtures, which are applicable analogously to building material compositions according to the invention.

The examples adduced hereinafter describe the present invention by way of example, without any intention that the invention, the scope of application of which is apparent from the entirety of the description and the claims, be restricted to the embodiments specified in the examples.

The low-emissions polyoxyalkylenes according to the invention, the process for preparation thereof and the use according to the invention as shrinkage reducers are described below by way of example, without any intention that the invention should be confined to these illustrative embodiments.

### EXAMPLES

### GPC Measurements:

GPC measurements for determining the polydispersity and average molar masses Mw were conducted under the following measurement conditions: SDV 1000/10 000 Å column combination (length 65 cm), temperature 30° C., THF as mobile phase, flow rate 1 ml/min, sample concentration 10 g/l, RI detector, evaluation against polypropylene glycol standard.

### Determination of OH Number:

Hydroxyl numbers were determined according to the method DGF C-V 17 a (53) of the Deutsche Gesellschaft für Fettwissenschaft [German Society for Fat Science]. This involved acetylating the samples with acetic anhydride in the presence of pyridine and determining the consumption of acetic anhydride by titration with 0.5 n potassium hydroxide solution in ethanol using phenolphthalein.

### Determination of Viscosity

Viscosities were measured in accordance with DIN 53019 with a Haake RV12 rotary viscometer at 25° C.

### Determination of the VOC Content:

### a) Test Chamber Experiments

Test chamber experiments were conducted in accordance with the test method “Bestimmung fluichtiger organischer Verbindungen zur Charakterisierung emissionskontrollierter Verlegewerkstoffe, Klebstoffe, Bauprodukte und Parkettlacke” [Determination of Volatile Organic Compounds for Characterization of Emissions-Controlled Laying Materials, Adhesives, Construction Products and Parquet Varnishes] from the German Association for the Control of Emissions in Products for Flooring Installation, Adhesives and Building Materials (GEV), version of Apr. 15, 2013. Mortar samples that contained the respective shrinkage reducer were made up with water, introduced into a metal dish and placed into a 30 l test chamber. Storage was effected at 23° C., 50% rel. humidity and exchange of air at 0.5 per hour. After 3, 10 and 28 days, two samples each were taken from the gas space of the test chamber: one sample for the analysis of the emissions by GC-MS (Tenax), the other sample for determination of aldehydes by means of HPLC (DNPH).

### b) Quick Method by Means of GC

VOC measurements were conducted according to DIN EN ISO 11890-2 “Paints and varnishes—Determination of volatile organic compound (VOC) content” by a gas chromatography method, using tetradecane having a boiling point of 251° C. under standard conditions as marker substance. VOCs are considered to be all compounds having retention times below that of the marker substance. The VOC content was determined by calculation from the peak areas and represents the proportion by mass of volatile organic constituents in percent based on the total amount of the sample analyzed.

### Mixing of the Building Material (Building Material Mixture):

The production of a mixture was effected in accordance with DIN EN 206-1. Cement and any admixtures, additives and aggregate were premixed in a mixer, for example a pan mixer. After completion of addition of water and after subsequent addition of superplasticizer or concrete plasticizer, the mixture was mixed again in each case.

### Determination of the Consistency of the Fresh Building Material Mixture:

Slump flow was determined according to DIN EN 12350-5 or according to DIN EN 13395-1. The determination of slump was conducted in accordance with DIN EN 12350-8. Rather than the “slump cone”, a “Hägermann cone” was used. Further methods employed are described in the DAfStb [German Committee for Structural Concrete] guide “Herstellung und Verwendung von zementgebundenem Vergussbeton und Vergussmörtel” [Production and Use of Cement-Bound Pouring Concrete and Pouring Mortar].

### Determination of the Air Pore Content of the Fresh Building Material Mixture:

The air pore content was determined in accordance with DIN EN 12350-7. The volume of the air content test instrument was 1 litre or 5 litres.

### Determination of Early Shrinkage:

Shrinkage and expansion operations in the building material samples during the setting process were measured by means of a shrinkage channel. Fresh mortar is introduced into a metal channel made of stainless steel. A ram mounted in a movable manner on one side of the channel transmits the change in length to a highly sensitive transducer. At the other end of the channel is a barbed hook that holds the sample against the wall of the channel. An identical hook is present on the transducer ram. The sample is held in a virtually frictionless manner in the channel.

### Determination of the Long-Term Shrinkage of the Solid Building Material Mixture:

Shrinkage was conducted according to DIN 52450 (1985). The alternative method is based on this standard. The difference is that test specimens with dimensions of 100 mm×100 mm×500 mm and corresponding test instruments were used.

### Determination of Compressive and Flexural Tensile Strengths of the Solid Building Material Mixture:

Compressive and flexural tensile strengths were tested according to DIN EN 12390-3, DIN EN 12390-5, DIN EN 196-1 and DIN EN 13892-2.

### Synthesis Examples for the Shrinkage Reducers

### Example 1

### Preparation of a Polyoxyalkylene from 3,5,5-trimethylhexanoic Acid and 8 Mol of PO

An initial charge of 806 g of 3,5,5-trimethylhexanoic acid and 18.5 g of KOH in a 5 litre autoclave was heated to 130° C. while stirring. The reactor was evacuated down to an internal pressure of 30 mbar in order to remove any volatile ingredients present by distillation, and inertization was effected with nitrogen. 2367 g of propylene oxide were metered in at internal temperature 130° C. and an internal pressure of 3 to 4 bar (absolute) within 4 h. After further reaction at 130° C. for 1.5 h, volatile components were removed by distillation under reduced pressure at 130° C. The alkoxylation product was cooled down to below 90° C., neutralized with phosphoric acid and discharged from the reactor via a filter. The product was almost colorless and of low viscosity at room temperature. The OH number was 101 mg KOH/g, and the acid number 0.1 mg KOH/g. According to GPC analysis, the product has a weight-average molar mass M_{w} of 680 g/mol and a polydispersity M_{w}/Mₙ of 1.11.

### Example 2

### Preparation of a Polyoxyalkylene from 3,5,5-trimethylhexanoic Acid and 12 Mol of EO

An initial charge of 806 g of 3,5,5-trimethylhexanoic acid and 12.5 g of KOH in a 5 litre autoclave was heated to 130° C. while stirring. The reactor was evacuated down to an internal pressure of 30 mbar in order to remove any volatile ingredients present by distillation, and inertization was effected with nitrogen. 2689 g of ethylene oxide were metered in at internal temperature 160° C. and an internal pressure of max. 4.5 bar (absolute) within 2 h 40 min. After further reaction at 160° C. for 1 h, volatile components were removed by distillation under reduced pressure at 160° C. The alkoxylation product was cooled down to below 90° C., neutralized with phosphoric acid and discharged from the reactor via a filter. The product was almost colorless and of low viscosity at room temperature. The OH number was 88.5 mg KOH/g, and the acid number 0.3 mg KOH/g. According to GPC analysis, the product has a weight-average molar mass M_{w} of 680 g/mol and a polydispersity M_{w}/Mₙ of 1.12.

### Example 3

### Preparation of a Polyoxyalkylene from Neodecanoic Acid and 8 Mol of EO

An initial charge of 689 g of neodecanoic acid and 3.6 g of potassium hydroxide solution (45%) in a 5 litre autoclave was heated to 130° C. while stirring. The reactor was evacuated down to an internal pressure of 30 mbar in order to remove any volatile ingredients present by distillation, and inertization was effected with nitrogen. 1408 g of ethylene oxide were metered in at internal temperature 170° C. and an internal pressure of max. 4.5 bar (absolute) within 3.5 h. After further reaction at 170° C. for 0.5 h, volatile components were removed by distillation under reduced pressure. The alkoxylation product was cooled down to below 90° C., neutralized with lactic acid and discharged from the reactor via a filter. The product was almost colorless and of low viscosity at room temperature. The OH number was 101.9 mg KOH/g, and the acid number 0.1 mg KOH/g. According to GPC analysis, the product has a weight-average molar mass M_{w} of 540 g/mol and a polydispersity M_{w}/Mₙ of 1.09.

### Example 4

### Preparation of a Polyoxyalkylene from 3,5,5-trimethylhexanoic Acid, 8 Mol of PO and 8 Mol of EO

Preparation according to Example 1, except that the autoclave was initially charged with 403 g of 3,5,5-trimethylhexanoic acid and 5.8 g of potassium methoxide, and a homogeneous mixture of 1182 g of propylene oxide and 897 g of ethylene oxide was metered in at 130° C. The phosphoric acid-neutralized alkoxylation product was almost colorless and of low viscosity at room temperature. The OH number was 58.2 mg KOH/g, and the acid number 0.2 mg KOH/g.

According to GPC analysis, the product has a weight-average molar mass M_{w} of 935 g/mol and a polydispersity M_{w}/Mₙ of 1.12.

### Example 5

### Preparation of a Polyoxyalkylene from Benzoic Acid and 5 Mol of EO and 5 Mol of PO

Preparation according to Example 1, except that the autoclave was initially charged with 488 g of benzoic acid and 7.5 g of sodium methoxide, and first 880 g of ethylene oxide and then 1160 g of propylene oxide were metered in at 130° C. The phosphoric acid-neutralized alkoxylation product of blockwise structure was pale yellowish and of low viscosity at room temperature. The OH number was 90.1 mg KOH/g, and the acid number 0.1 mg KOH/g. According to GPC analysis, the product has a weight-average molar mass M_{w} of 610 g/mol and a polydispersity M_{w}/Mₙ of 1.14.

### Example 6

### Preparation of a Polyoxyalkylene from Oleic Acid and 12 Mol of EO

Preparation according to Example 3, except that the autoclave was initially charged with 561 g of oleic acid and 2.5 g of potassium hydroxide solution (45%), and 1056 g of ethylene oxide were metered in at 150° C. The non-neutralized alkoxylation product was brownish and of low viscosity at room temperature. The OH number was 71.3 mg KOH/g, and the acid number 0.0 mg KOH/g. According to GPC analysis, the product has a weight-average molar mass M_{w} of 785 g/mol and a polydispersity M_{w}/Mₙ of 1.16.

### Example 7

### Preparation of a Powder in Supported Form

The stirrer bowl of an intensive mixer (for example from Eirisch) was initially charged with 333 g of silica and 67 g of the polyoxyalkylene according to Example 1 (3,5,5-trimethylhexanoic acid+8 PO). This was followed by mixing at 2000 rpm for 5 minutes.

### Analysis of VOC Content:

The pure polyoxyalkylenes were analyzed for their VOC content by gas chromatography by the quick test described.

TABLE 1
VOC content of shrinkage reducers

| | | VOC relative to |
|---|---|---|
| | | hexylene glycol |
| Example | Shrinkage reducer | (%) |
| (noninventive) | hexylene glycol | 100 |
| (noninventive) | neopentyl glycol | 100 |
| 1 | 3,5,5-trimethylhexanoic acid + 8 PO | 0.29 |
| 2 | 3,5,5-trimethylhexanoic acid + 12 EO | <0.1 |
| 3 | neodecanoic acid + 8 EO | <0.1 |
| 4 | 3,5,5-trimethylhexanoic acid + 8 PO/ | <0.1 |
| | 8 EO | |
| 5 | benzoic acid + 5 EO + 5 PO | 0.2 |
| 6 | oleic acid + 12 EO | <0.1 |

For selected samples, by the GEV method, test chamber tests (as described above) on mortar samples modified with various shrinkage reducers were conducted. The dosage was 0.3% active ingredient based on the overall mortar.

For the assessment of VOC emissions, what is called the TVOC (total volatile organic content; retention range C6-C16) is cited and is reported in toluene equivalents.

TABLE 2
TVOC values of mortar samples with shrinkage reducers
in the test chamber test by the GEV method

| | TVOC on day 3 | | TVOC on day 28 | |
|---|---|---|---|---|
| Conventional shrinkage | | | | |
| reducer | | | | |
| neopentyl glycol | 3710 | μg/m³ | 1980 | μg/m³ |
| Inventive compound | 50 | μg/m³ | <10 | μg/m³ |
| Example 1 | | | | |
| Limit under GEV criteria*: | | | | |
| e.g. EC1^{plus} | ≤750 | μg/m³ | ≤60 | μg/m³ |
| e.g. EC1 | ≤1000 | μg/m³ | ≤100 | μg/m³ |
| e.g. EC2 | ≤3000 | μg/m³ | ≤300 | μg/m³ |

*for product group 1: mineral products.

The conventional shrinkage reducer does not meet any of the GEV criteria that currently represent the state of the art for low-emissions building materials. By contrast, the mortar with the inventive shrinkage reducer (Example 1) achieves a level several times below the GEV criteria. The further compounds of the invention according to Examples 2 to 7 achieve comparably low TVOC values.

The detection of the shrinkage-reducing properties of the substances according to the invention was conducted on a building material mixture formulation consisting inter alia of 330 kg/m³ cement, 1700 kg/m³ rock flour and aggregate, and 210 kg of water. The difference between the comparative mixtures was merely in the shrinkage-reducing component.

TABLE 3
Indices of the fresh and solid building material mixture:

| | MIXTURE | | | | | | |
|---|---|---|---|---|---|---|---|
| | A | B | C | D | E | F | G |
| Shrinkage | none | neopentyl | hexylene | from | from | from | from |
| reducer (SR) | | glycol | glycol | Ex. 1 | Ex. 2 | Ex. 3 | Ex. 4 |
| SR dosage | — | 2.0% | 2.0% | 2.0% | 2.0% | 2.0% | 2.0% |
| [% by wt. of | | | | | | | |
| cement] | | | | | | | |
| Slump after | 235 | 240 | 230 | 225 | 230 | 240 | 230 |
| 5 min | mm | mm | mm | mm | mm | mm | mm |
| Compressive | 34.8 | 34.5 | 33.7 | 39.2 | 31.1 | 33.4 | 35.7 |
| strength after | MPa | MPa | MPa | MPa | MPa | MPa | MPa |
| 28 d | | | | | | | |

TABLE 4
Early shrinkage values: The figures given are standardized
to the reference mixture. By definition, the values for
the reference mixture at every measurement point are 100%.
A value of less than 100% means that the shrinkage of
this mixture was less than the reference mixture.

| | A | B | C | D | E | F | G |
|---|---|---|---|---|---|---|---|
| 1 h | 100% | 30.0% | 32.9% | 12.9% | 25.7% | 100.4% | 28.6% |
| 5 h | 100% | 26.0% | 41.0% | 25.3% | 76.4% | 85.5% | 24.9% |
| 10 h | 100% | 35.4% | 20.2% | 59.4% | 64.2% | 65.0% | 21.9% |
| 15 h | 100% | 68.8% | 26.8% | 42.7% | 76.3% | 41.3% | 33.8% |
| 20 h | 100% | 77.8% | 58.1% | 43.2% | 69.2% | 46.1% | 42.6% |
| 24 h | 100% | 78.3% | 65.7% | 43.2% | 67.8% | 47.0% | 44.6% |
| 32 h | 100% | 78.6% | 67.3% | 42.9% | 67.5% | 46.8% | 44.8% |
| 48 h | 100% | 77.6% | 67.0% | 42.3% | 66.7% | 46.2% | 44.8% |

TABLE 5
Long-term shrinkage values according to Graf-Kaufmann

| | A | B | C | D | E | F | G |
|---|---|---|---|---|---|---|---|
| | [mm/m] | [mm/m] | [mm/m] | [mm/m] | [mm/m] | [mm/m] | [mm/m] |
| 1 d | −0.253 | −0.247 | −0.169 | −0.051 | −0.182 | −0.140 | −0.044 |
| 5 d | −0.476 | −0.333 | −0.300 | −0.218 | n.d. | −0.316 | −0.227 |
| 7 d | n.d. | −0.393 | −0.333 | −0.278 | −0.391 | −0.407 | −0.284 |
| 14 d | −0.589 | −0.473 | −0.422 | −0.351 | n.d. | −0.491 | −0.364 |
| 21 d | −0.633 | −0.498 | −0.460 | −0.376 | −0.511 | −0.511 | −0.387 |
| 28 d | −0.638 | −0.507 | −0.496 | −0.391 | −0.516 | −0.531 | −0.402 |
| 56 d | −0.688 | −0.520 | −0.498 | −0.451 | n.d. | −0.563 | −0.470 |

The shrinkage-reducing properties of the compounds according to the invention were tested in a further building material formulation (Table 6) of the following composition: 647 kg/m³ cement, 260 kg/m³ rock flour, 1293 kg/m³ sand of grain size 0-2 mm and 453 kg/m³ water. References used were mixtures without shrinkage reducer and with neopentyl glycol. Shrinkage was conducted according to DIN 52450 (1985) on test specimens with dimensions of 400 mm×400 mm×1600 mm.

TABLE 6
Long-term shrinkage values according to DIN 52450 (1985)

| | | Neopentyl | | | |
|---|---|---|---|---|---|
| | no SR | glycol | from Ex. 1 | from Ex. 2 | from Ex. 4 |
| | [mm/m] | [mm/m] | [mm/m] | [mm/m] | [mm/m] |
| 1 d | −0.10 | −0.09 | −0.05 | −0.12 | −0.06 |
| 7 d | −0.44 | −0.30 | −0.25 | −0.35 | −0.15 |
| 14 d | −0.76 | −0.38 | −0.39 | −0.40 | −0.30 |
| 21 d | −0.89 | −0.58 | −0.50 | −0.60 | −0.51 |
| 28 d | −1.00 | −0.62 | −0.65 | −0.70 | −0.55 |
| 56 d | −1.15 | −0.72 | −0.65 | −0.72 | −0.62 |

1. A shrinkage-reducing agent comprising a polyoxyalkylene of the formula (I) 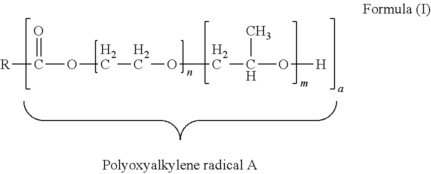
wherein
R is independently an a-valent, linear or branched, saturated, monounsaturated or polyunsaturated, aliphatic, cycloaliphatic or aromatic hydrocarbyl radical having 3 to 38 carbon atoms, where the hydrocarbyl radical is substituted by a polyoxyalkylene radicals A,
a is from 1 to 4,
n is from 0 to 40,
m is from 0 to 40,
wherein
the sum total of n and m=4 to 80, where the units that n and m refer to are distributed in the polyether chain either in blocks or randomly and the units that n and m refer to constitute the mean values of the possible statistical distribution of the actual structures present.

2. The shrinkage-reducing agent according to claim 1, wherein, in formula (I), the R radical is independently an aliphatic hydrocarbyl radical having from 3 to 38 carbon atoms, where the carbon chain is terminally substituted by 1 or 2 polyoxyalkylene radicals A and a is the number of polyoxyalkylene radicals A and is 1 or 2.

3. The shrinkage-reducing agent according to claim 1, wherein the R radicals derive from a fatty acid or a dimer fatty acid.

4. The shrinkage-reducing agent according to claim 1, wherein the R radicals derive from hexanoic acid, heptanoic acid, octanoic acid, nonanoic acid, decanoic acid, undecanoic acid, dodecanoic acid, tridecanoic acid, tetradecanoic acid, pentadecanoic acid, hexadecanoic acid, heptadecanoic acid, octadecanoic acid, nonadecanoic acid, eicosanoic acid, 2-ethylhexanecarboxylic acid, isononanoic acid, 3,5,5-trimethylhexanecarboxylic acid, neodecanoic acid, isotridecanecarboxylic acid, isostearic acid, undecylenoic acid, oleic acid, linoleic acid, ricinoleic acid, linolenic acid, benzoic acid, cinnamic acid, phthalic acid, isophthalic acid, terephthalic acid, cyclohexanecarboxylic acid, hexahydrophthalic acid, tetrahydrophthalic acid, methyltetrahydrophthalic acid or the dimer fatty acids that derive from the aforementioned unsaturated carboxylic acids.

5. The shrinkage-reducing agent according to claim 1, wherein, in formula (I), a is less than 3.

6. The shrinkage-reducing agent according to claim 1, wherein, in formula (I), m=2 to 30 and n=2 to 30, and the sum total of n and m is 6 to 40.

7. The shrinkage-reducing agent according to claim 1, wherein the polyoxyalkylenes of the formula (I) have a weight-average molar mass of 300 to 15 000 g/mol.

8. The shrinkage-reducing agent according to claim 1, wherein the polyoxyalkylenes of the formula (I) have been applied to a support.

9. The method of reducing shrinkage of building materials comprising mineral binders, especially cementitious binders, preferably of mortar, screed, concrete or slurries, wherein at least one polyoxyalkylene of the formula (I) according to the provisions of claim 1 is added to an unhardened building material mixture.

10. The method according to claim 9, wherein the polyoxyalkylene of the formula (I) is added to the building material mixture in an amount of 0.001% to 6.0% by weight, based on the dry weight of the mineral binder.

11. The method according to claim 9, wherein the building material mixture comprises customary admixtures and/or additives and/or aggregate.

12. The method according to claim 9, wherein
i) the at least one polyoxyalkylene of the formula (I), mineral binders, admixtures, additives and/or aggregate are mixed without addition of water and water is added to the premix thus obtained at a later juncture, or
ii) the individual components are mixed together with water.

13. The method according to claim 9, wherein the at least one polyoxyalkylene of the formula (I) is mixed with the mineral binder and/or the rock flour during the process of production or delivery of the building material.

14. The building material composition comprising
i) at least one mineral binder, preferably a cementitious binder, and
ii) at least one polyoxyalkylene of the formula (I)
according to the provisions from claim 1.

15. The shrinkage-reducing agent according to claim 1, wherein, in formula (I), a is less than 1.

16. The shrinkage-reducing agent according to claim 1, wherein, in formula (I), m is from 4 to 20, and n is from 4 to 20, and the sum total of n and m is from 8 to 20.

17. The use according to claim 1, wherein the polyoxyalkylenes of the formula (I) have a weight-average molar mass of 500 to 2500 g/mol.

18. The method according to claim 9, wherein the polyoxyalkylene of the formula (I) is added to the building material mixture in an amount of 0.1% to 3% by weight, based on the dry weight of the mineral binder.

19. The shrinkage-reducing agent according to claim 2, wherein the R radicals derive from hexanoic acid, heptanoic acid, octanoic acid, nonanoic acid, decanoic acid, undecanoic acid, dodecanoic acid, tridecanoic acid, tetradecanoic acid, pentadecanoic acid, hexadecanoic acid, heptadecanoic acid, octadecanoic acid, nonadecanoic acid, eicosanoic acid, 2-ethylhexanecarboxylic acid, isononanoic acid, 3,5,5-trimethylhexanecarboxylic acid, neodecanoic acid, isotridecanecarboxylic acid, isostearic acid, undecylenoic acid, oleic acid, linoleic acid, ricinoleic acid, linolenic acid, benzoic acid, cinnamic acid, phthalic acid, isophthalic acid, terephthalic acid, cyclohexanecarboxylic acid, hexahydrophthalic acid, tetrahydrophthalic acid, methyltetrahydrophthalic acid or the dimer fatty acids that derive from the aforementioned unsaturated carboxylic acids.

20. The shrinkage-reducing agent according to claim 1, wherein, in formula (I), the R radical is independently an aliphatic hydrocarbyl radical having from 5 to 17 carbon atoms, where the carbon chain is terminally substituted by 1 or 2 polyoxyalkylene radicals A and a is the number of polyoxyalkylene radicals A and is 1 or 2.
